(19) United States
(12) Patent Application Publication
(10) Pub. No.: US 2022/0410860 A1
(43) Pub. Date: Dec. 29, 2022

(54) BRAKING CONTROL DEVICE FOR VEHICLE

(71) Applicant: ADVICS CO., LTD., Kariya-shi, Aichi-ken (JP)

(72) Inventors: Kazuya MORISHITA, Kariya-shi, Aichi-ken (JP); Daijiro UCHIDA, Kariya-shi, Aichi-ken (JP)

(73) Assignee: ADVICS CO., LTD., Kariya-shi, Aichi-ken (JP)

(21) Appl. No.: 17/779,022

(22) PCT Filed: Nov. 25, 2020
(86) PCT No.: PCT/JP2020/043726

§ 371 Date: May 23, 2022

(30) Foreign Application Priority Data
Nov. 25, 2019 (JP) 2019-211968

(51) Int. Cl. B60T 13/20; B60T 13/68; B60T 7/12

(52) U.S. Cl. CPC B60T 13/20; B60T 13/686; B60T 7/12

(57) ABSTRACT

The braking control device decelerates a vehicle by automatically increasing a brake fluid pressure as a hydraulic pressure in a wheel cylinder at the time when a braking operation member is not operated, and includes: a pressure regulating valve provided to a connection path for connecting a master cylinder and the wheel cylinder and regulating a differential pressure between a master cylinder hydraulic pressure as a hydraulic pressure in the master cylinder and the brake fluid pressure; a fluid pump driven by an electric motor and discharging a brake fluid into the connection path between the pressure regulating valve and the wheel cylinder; and a controller controlling the pressure regulating valve and the electric motor. When the brake fluid pressure no longer has to be increased, the controller closes the pressure regulating valve and stops driving the electric motor.

### TECHNICAL FIELD

The present disclosure relates to a braking control device for a vehicle.

### BACKGROUND ART

For a purpose of “suppressing controllability of body deceleration of a vehicle from being degraded at the time when a drive speed of an electric motor is reduced”, the present applicant has developed “a control device 100 as a braking control device that includes: a valve control section 103 controlling a differential pressure regulating valve 62 and a holding valve 64; and a motor control section 102 controlling an electric motor 67 as a power source of a pump 68, in which, when a specified condition is satisfied during execution of automatic braking processing to decelerate the vehicle, the valve control section 103 executes valve opening degree changing control for reducing an opening degree of the holding valve 64 to be smaller than that before the specified condition is satisfied, and in which the motor control section 102 executes speed changing control for changing a drive speed of the electric motor 67 from a first drive speed to a second drive speed in a situation where the opening degree of the holding valve 64 is made smaller than that before the specified condition is satisfied by the valve opening degree changing control during the execution of the automatic braking processing” as disclosed in PTL 1.

For example, in the device disclosed in PTL 1, when the automatic braking processing starts being executed, a braking actuator 60 starts being actuated to hold a target WC pressure PwcTr such that a drive speed Vmt of the electric motor 67 is held at a steady speed VmtS, that a differential pressure command current value Ism for each of the differential pressure regulating valves 62 (also simply referred to as “differential pressure valves”) is increased with an increase in the target WC pressure PwcTr, and that body deceleration DVS of the vehicle is maintained to match target body deceleration DVSTh. When duration TM of a state of holding the target WC pressure PwcTr reaches determination duration TMTh, a condition for holding a WC pressure Pwc is satisfied, and the valve opening degree changing control is started. Each of the holding valves 64 (also referred to as “inlet valves”) is closed, the speed changing control is started at a time point t14 after a lapse of a certain period, and the electric motor 67 stops being driven. In a transition period in which the drive speed Vmt of the electric motor 67 is being changed, each of the holding valves 64 is closed. Accordingly, even when a discharge amount of a brake fluid from the pump 68 is reduced, a fluctuation in the WC pressure Pwc in each wheel cylinder 21 is suppressed, and thus it is possible to suppress controllability of the body deceleration DVS of the vehicle from being degraded.

By the way, in regard to the braking control device for the vehicle as disclosed in PTL 1 that executes the automatic braking processing (also referred to as “automatic braking control”), in addition to the suppression of the fluctuation in the deceleration of the vehicle, power saving is desired for the braking control device.

### CITATION LIST

### Patent Literature

PTL 1: JP-A-2018-154300

### SUMMARY

### Technical Problem

The present disclosure has a purpose of providing a braking control device for a vehicle capable of executing automatic braking control and capable of power saving.

### Solution to Problem

A braking control device (SC) for a vehicle according to the present disclosure decelerates a vehicle by automatically increasing a brake fluid pressure (Pw) as a hydraulic pressure in a wheel cylinder (CW) at the time when a braking operation member (BP) is not operated, and includes: a “pressure regulating valve (UA) that is provided to a connection path (HS) for connecting a master cylinder (CM) and the wheel cylinder (CW) and regulates a differential pressure (Sa) between a master cylinder hydraulic pressure (Pm) as a hydraulic pressure in the master cylinder (CM) and the brake fluid pressure (Pw)”; a “fluid pump (HP) that is driven by an electric motor (MT) and discharges a brake fluid (BF) into the connection path (HS) between the pressure regulating valve (UA) and the wheel cylinder (CW)”; and a “controller (ECU) that controls the pressure regulating valve (UA) and the electric motor (MT)”. Then, in the case where the brake fluid pressure (Pw) no longer has to be increased, the controller (ECU) closes the pressure regulating valve (UA) and stops driving the electric motor (MT). For example, the pressure regulating valve (UA) is of a normally-open type, and the controller (ECU) increases an energization amount (Ia) to be supplied to the pressure regulating valve (UA) by a predetermined energization amount (ip) at a time point at which the brake fluid pressure (Pw) no longer has to be increased.

According to the above configuration, when the brake fluid pressure Pw no longer has to be increased, the brake fluid pressure Pw is held by closing the pressure regulating valve UA, and power supply to the electric motor MT is stopped. Therefore, power saving for the braking control device SC is achieved.

### BRIEF DESCRIPTION OF DRAWINGS

FIG. 1 is an overall configuration view for explaining an embodiment of a braking control device SC for a vehicle.

FIG. 2 is a flowchart for explaining processing in automatic braking control including motor stop control.

FIG. 3 is a time chart for explaining actuation of the motor stop control.

### DESCRIPTION OF EMBODIMENTS

### Reference Signs for Components and the Like, and Subscripts at Ends of Reference Signs

In the following description, components, elements, signals, characteristics, and the like denoted by the same reference signs such as “CW” have the same functions. Subscripts “1”, “2” that are provided at ends of the reference signs related to two brake systems are inclusive signs indicating which system is referred, and “1” indicates one brake system (also referred to as a “first brake system BK1”) while “2” indicates the other brake system (also referred to as a “second brake system BK2”). For example, of two pressure chambers (also referred to as “hydraulic chambers”) of a tandem master cylinder CM, one that is connected to the first brake system BK1 is a first hydraulic chamber Rm1, and one that is connected to the second brake system BK2 is a second hydraulic chamber Rm2. The subscripts “1”, “2” can be omitted. When the subscripts “1”, “2” are omitted, the reference sign represents a collective term.

For example, “Rm” represents the hydraulic chamber. In a connection path HS, a portion on a side near the master cylinder CM (or a side far from a wheel cylinder CW) will be referred to as an “upstream portion”, and a portion on a side near the wheel cylinder CW will be referred to as a “downstream portion”.

### Embodiment of Braking Control Device SC for Vehicle

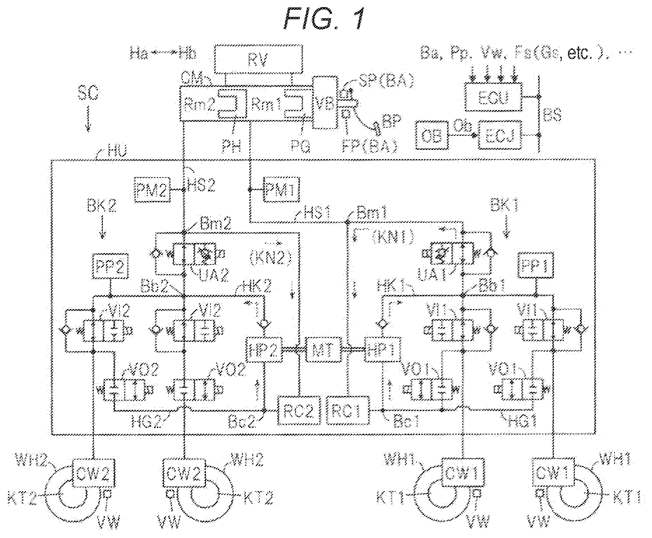

A description will be made on an embodiment of a braking control device SC according to the present disclosure with reference to an overall configuration view in FIG. 1. In the embodiment, in regard to a fluid path of two systems (the first and second brake systems BK1, BK2), in the first brake system BK1, a first hydraulic chamber Rm1 is connected to wheel cylinders (referred to as “first wheel cylinders CW1”) of a front right wheel and a rear left wheel. In the second brake system BK2, a second hydraulic chamber Rm2 is connected to wheel cylinders (referred to as “second wheel cylinders CW2”) of a front left wheel and a rear right wheel. That is, a diagonal (also referred to as an “X-type”) fluid path is adopted as the fluid path of the two systems. Here, the “fluid path” is a path through which a brake fluid BF as a hydraulic fluid moves, and a brake pipe, a flow path of a fluid unit HU, a hose, and the like correspond thereto.

A vehicle including the braking control device SC is provided with a braking operation member BP, a rotary member KT, the wheel cylinder CW, a master reservoir RV, the master cylinder CM, a braking operation amount sensor BA, a deceleration sensor GX, and a wheel speed sensor VW.

The braking operation member (for example, a brake pedal) BP is a member that is operated by a driver to decelerate the vehicle. When the braking operation member BP is operated, braking torque Tq of a wheel WH is regulated, and a braking force is generated to the wheel WH. More specifically, the rotary member (for example, a brake disc) KT is fixed to the wheel WH of the vehicle. In addition, a brake caliper is arranged to sandwich the rotary member KT.

The brake caliper is provided with the wheel cylinder CW. When a pressure (a “wheel cylinder hydraulic pressure”, also referred to as a “brake fluid pressure”) Pw of the brake fluid BF in the wheel cylinder CW is increased, a friction member (for example, a brake pad) is pressed against the rotary member KT. Since the rotary member KT and the wheel WH are fixed to rotate integrally, the braking torque Tq is generated to the wheel WH by a friction force that is generated at this time. Then, the braking force (a frictional braking force) is generated to the wheel WH by the braking torque Tq.

The master reservoir (also referred to as an “atmospheric pressure reservoir”) RV is a tank for the hydraulic fluid, and stores the brake fluid BF therein. A piston PG in the master cylinder CM is mechanically connected to the braking operation member BP via a brake rod and the like. A tandem master cylinder is adopted as the master cylinder CM. In the master cylinder CM, the two hydraulic chambers Rm1, Rm2 (=Rm) are formed by the primary piston PG and a secondary piston PH. When the braking operation member BP is not operated, each of the first and second hydraulic chambers Rm1, Rm2 (also referred to as “master cylinder chambers”) of the master cylinder CM communicates with the master reservoir RV. In the case where the brake fluid BF is insufficient in the first and second braking systems BK1, BK2, the brake fluid BF is replenished from the master reservoir RV to the hydraulic chambers Rm.

When the braking operation member BP is operated, the primary and secondary pistons PG, PH in the master cylinder CM are pushed in an advancing direction Ha, and the master cylinder chamber (the hydraulic chamber) Rm (=Rm1, Rm2) is blocked from the master reservoir RV. Furthermore, when the operation of the braking operation member BP is increased, the pistons PG, PH further move in the advancing direction Ha, a volume of the hydraulic chamber Rm is reduced, and the brake fluid (working fluid) BF is discharged (pressure-fed) from the master cylinder CM. As the operation of the braking operation member BP is reduced, the pistons PG, PH move in a retreating direction Hb, the volume of the hydraulic chamber Rm is increased, and the brake fluid BF is returned toward the master cylinder CM.

The first hydraulic chamber Rm1 of the tandem master cylinder CM and the first wheel cylinder CW1 are connected by a first connection path HS1. The second hydraulic chamber Rm2 and the second wheel cylinder CW2 are connected by a second connection path HS2. The first and second connection paths HS1, HS2 are fluid paths for connecting the master cylinder CM (in particular, the hydraulic chambers Rm1, Rm2) and the first and second wheel cylinders CW1, CW2, respectively. The first and second connection paths HS1, HS2 are each divided into two by branch sections Bb1, Bb2, respectively, and are respectively connected to the first and second wheel cylinders CW1, CW2.

The braking operation amount sensor BA detects an operation amount Ba of the braking operation member (brake pedal) BP by the driver. More specifically, as the braking operation amount sensor BA, at least one of a master cylinder hydraulic pressure sensor PM (=PM1, PM2) that detects a hydraulic pressure (master cylinder hydraulic pressure) Pm (=Pm1, Pm2) in the hydraulic chamber Rm, an operation displacement sensor SP that detects operation displacement Sp of the braking operation member BP, and an operation force sensor FP that detects an operation force Fp of the braking operation member BP is adopted. In other words, the braking operation amount sensor BA is a collective term for the master cylinder hydraulic pressure sensor PM, the operation displacement sensor SP, and the operation force sensor FP, and the braking operation amount Ba is a collective term for the master cylinder hydraulic pressure Pm, the operation displacement Sp, and the operation force Fp.

The deceleration sensor GX (not illustrated) detects actual deceleration Gx of the vehicle. The wheel speed sensor VW detects a wheel speed Vw that is a rotational speed of each of the wheels WH. A signal of the wheel speed Vw is adopted for anti-lock brake control to suppress a locking tendency of the wheel WH, and the like. The wheel speeds Vw detected by the wheel speed sensors VW are each input to a braking controller (also simply referred to as a controller) ECU. In the controller ECU, a body speed Vx is calculated on the basis of the wheel speed Vw.

### Driver-Assistance System

The vehicle includes a driver-assistance system to automatically stop the vehicle (that is, execute automatic braking control) on behalf of or to assist the driver via the braking control device SC. The driver-assistance system is configured to include a distance sensor OB and a driver-assistance controller ECJ.

The distance sensor OB detects a distance (relative distance) Ob between an object (another vehicle, a fixed object, a person, a bicycle, a stop line, a sign, a signal, or the like) present in front of an own vehicle and the own vehicle. For example, an image sensor, a radar sensor, an ultrasonic sensor, or the like is adopted as the distance sensor OB. Alternatively, information from the Global Positioning System (GPS) mounted to the vehicle may be referred for map information, and the relative distance Ob may thereby be calculated. The relative distance Ob is input to the driver-assistance controller ECJ.

In the driver-assistance controller ECJ, required deceleration Gs is calculated on the basis of the relative distance Ob. The required deceleration Gs is a target value of vehicle deceleration for executing the automatic braking control. Here, since vehicle mass and specifications (a pressure-receiving area of the wheel cylinder CW, an effective braking radius, a friction coefficient of a friction material, and the like) of the brake system have already been known, the required deceleration Gs may be converted into a dimension (physical quantity) of the brake fluid pressure Pw and may be determined as a required hydraulic pressure Ps (a target value of the hydraulic pressure in the wheel cylinder CW). Alternatively, the required deceleration Gs may be converted and calculated into a dimension of the braking torque Tq, which is applied to the wheel WH, or the braking force, which is generated to the wheel WH. A state amount (state variable) related to the required deceleration Gs will be referred to as a “required deceleration corresponding value Fs”. In other words, the required deceleration corresponding value (also simply referred to as a “corresponding value”) Fs is determined by at least one dimension of the vehicle deceleration, the braking torque, the braking force, and the brake fluid pressure. The corresponding value Fs is sent to the braking controller ECU of the braking control device SC via a communication bus BS.

### Braking Control Device SC

The braking control device SC is constructed of a fluid unit HU and the braking controller ECU.

The fluid unit HU is provided to the first and second connection paths HS1, HS2. That is, the first and second hydraulic chambers Rm1, Rm2 are respectively connected to the first and second wheel cylinders CW1, CW2 via the fluid unit HU. The fluid unit HU is configured to include the first and second master cylinder hydraulic pressure sensors PM1, PM2, first and second fluid pumps HP1, HP2, an electric motor MT, first and second pressure regulating reservoirs RC1, RC2, first and second pressure regulating valves UA1, UA2, first and second regulated hydraulic pressure sensors PP1, PP2, first and second inlet valves VI1, VI2, and first and second outlet valves VO1, VO2.

In the upstream portions of the first and second pressure regulating valves UA1, UA2, the first and second master cylinder hydraulic pressure sensors PM1, PM2 are respectively provided to detect the hydraulic pressures (master cylinder hydraulic pressures) Pm1, Pm2 of the first and second hydraulic chambers Rm1, Rm2. The master cylinder hydraulic pressure sensor PM (=PM1, PM2) corresponds to the braking operation amount sensor BA, and the master cylinder hydraulic pressure Pm corresponds to the braking operation amount Ba. Since the first and second master cylinder hydraulic pressures Pm1, Pm2 are substantially the same, any one of the first and second master cylinder hydraulic pressure sensors PM1, PM2 can be omitted.

The first and second pressure regulating valves UA1, UA2 (=UA) are respective provided to the first and second connection paths HS1, HS2 (=HS). The pressure regulating valve UA is a normally-open linear solenoid valve (also referred to as a “differential pressure valve”) whose valve opening amount (lift amount) is continuously controlled according to an energization amount (current value). First and second recirculation paths HK1, HK2 (=HK) are provided to respectively connect upstream portions Bm1, Bm2 (=Bm) of the pressure regulating valve UA and the downstream portions Bb1, Bb2 (=Bb) of the pressure regulating valve UA. The recirculation paths HK are provided with the first and second fluid pumps HP1, HP2 (=HP) and the first and second pressure regulating reservoirs RC1, RC2 (=RC).

The fluid pump HP suctions the brake fluid BF from the upstream portion (a portion in the connection path HS between the master cylinder CM and the pressure regulating valve UA) Bm of the pressure regulating valve UA, and discharges the brake fluid BF to the downstream portion (a portion in the connection path HS between the pressure regulating valve UA and the wheel cylinder CW) Bb of the pressure regulating valve UA. The fluid pump HP is driven by the electric motor MT. When the electric motor MT is rotationally driven, in the recirculation paths HK, first and second recirculation flows KN1, KN2 (=KN) of the brake fluid BF are generated as indicated by broken arrows (flows in “HP→UA→RC→HP”). Here, the “recirculation flow” means that the brake fluid BF recirculates and returns to an original flow. The recirculation path HK is provided with a check valve to prevent a reverse flow of the brake fluid BF.

When the pressure regulating valve UA throttles the recirculation flow KN, a pressure difference (differential pressure) Sa is generated between the upstream portion of the pressure regulating valve UA (that is, the master cylinder hydraulic pressure Pm) and the downstream portion thereof (that is, the brake fluid pressure Pw). More specifically, when the controller ECU energizes the normally-open pressure regulating valve UA, the valve opening amount thereof is reduced, and the hydraulic pressure Pw in the wheel cylinder CW is regulated to be increased from the master cylinder hydraulic pressure Pm.

In the first and second connection paths HS1, HS2, the first and second regulated hydraulic pressure sensors PP1, PP2 (=PP) are respectively provided to detect hydraulic pressures (referred to as “first and second regulated hydraulic pressures”) Pp1, Pp2 (=Pp) that are respectively regulated by the first and second pressure regulating valves UA1, UA2. Since there is a correlation between the valve opening amount of the pressure regulating valve UA and supplied power, the regulated hydraulic pressure Pp can be regulated according to the energization amount (for example, a current amount) of the pressure regulating valve UA. In this case, the regulated hydraulic pressure sensor PP may not be provided.

In the first and second connection paths HS1, HS2, the downstream portions (the sides near the wheel cylinders CW) of the branch sections Bb1, Bb2 have the same configuration. The connection path HS (=HS1, HS2) is provided with the inlet valve VI (=VI1, VI2). A normally-open on/off solenoid valve is used as the inlet valve VI.

In downstream portions of the inlet valves VI (that is, between the inlet valves VI and the wheel cylinders CW), the connection paths HS are connected to first and second pressure reducing paths HG1, HG2 (=HG). In addition, the pressure reducing path HG is connected to the pressure regulating reservoir RC. The pressure reducing path HG is provided with the outlet valve VO (=VO1, VO2). A normally-closed on/off solenoid valve is used as the outlet valve VO.

In order to reduce the hydraulic pressure (brake fluid pressure) Pw in the wheel cylinder CW by the anti-lock brake control or the like, the inlet valve VI is brought into a closed position, and the outlet valve VO is brought into an open position. An inflow of the brake fluid BF from the inlet valve VI is inhibited, and the brake fluid BF in the wheel cylinder CW flows out to the pressure regulating reservoir RC, which reduces the brake fluid pressure Pw. On the contrary, in order to increase the brake fluid pressure Pw, the inlet valve VI is brought into the open position, and the outlet valve VO is brought into the closed position. An outflow of the brake fluid BF into the pressure regulating reservoir RC is inhibited, and the regulated hydraulic pressure Pp is introduced into the wheel cylinder CW, which increases the brake fluid pressure Pw. Furthermore, in order to hold the hydraulic pressure (brake fluid pressure) Pw in the wheel cylinder CW, both of the inlet valve VI and the outlet valve VO are closed. In other words, by controlling the solenoid valves VI, VO, the brake fluid pressure Pw (that is, the braking torque Tq) can independently be regulated in the wheel cylinder CW of each of the wheels WH.

The braking controller (also referred to as an “electronic control unit”) ECU is constructed of an electric circuit board, on which a microprocessor, a drive circuit, and the like are mounted, and a control algorithm programmed into the microprocessor. The controller ECU is connected to the other controllers (ECJ and the like) via a network so as to share signals (a detection value, a calculation value, and the like) via the on-board communication bus BS. For example, the braking controller ECU is connected to the driver-assistance controller ECJ through the communication bus BS. The body speed Vx is sent from the braking controller ECU to the driver-assistance controller ECJ. Meanwhile, the required deceleration corresponding value Fs (Gs, Ps, and the like) for executing the automatic braking control is sent from the driver-assistance controller ECJ to the braking controller ECU.

The braking controller ECU (electronic control unit) controls the electric motor MT and the solenoid valves UA, VI, VO in the fluid unit HU. More specifically, drive signals Ua, Vi, Vo for respectively controlling the various solenoid valves UA, VI, VO are calculated on the basis of the control algorithm in the microprocessor. Similarly, a drive signal Mt for controlling the electric motor MT is calculated.

The braking controller ECU receives the braking operation amount Ba (Pm, Sp, and the like), the wheel speed Vw, the regulated hydraulic pressure Pp, and the like. The braking controller ECU also receives the corresponding value Fs from the driver-assistance controller ECJ via the communication bus BS. The braking controller ECU executes the automatic braking control including motor stop control (will be described below) on the basis of the required deceleration corresponding value Fs.

### Processing of Automatic Braking Control Including Motor Stop Control

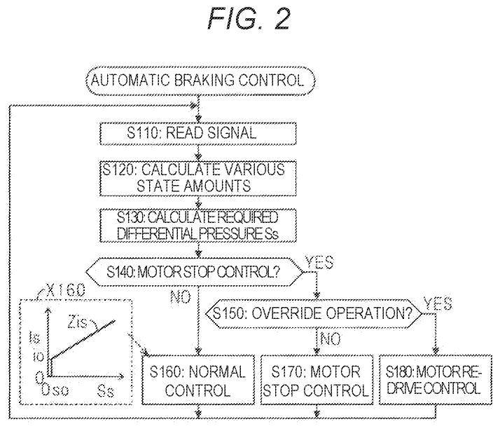

A description will be made on calculation processing in the automatic braking control including the motor stop control with reference to a flowchart in FIG. 2. The “automatic braking control” automatically brakes the vehicle on behalf of the driver on the basis of the value Fs corresponding to the required deceleration Gs. For example, the automatic braking control is executed when the braking operation member BP is not operated (that is, “Ba=0”), and the brake fluid pressure Pw is automatically increased. In addition, even when the braking operation member BP is operated (that is, “Ba>0”), the automatic braking control is executed to increase the brake fluid pressure Pw to be higher than the master cylinder hydraulic pressure Pm (that is, the hydraulic pressure difference Sa between the master cylinder hydraulic pressure Pm and the brake fluid pressure Pw is regulated). The “motor stop control” stops the energization of the electric motor MT to bring a rotational frequency thereof to “0” in order to reduce the power consumed by the braking control device SC during execution of the automatic braking control. These types of the calculation processing are programmed into the microprocessor in the controller ECU (electronic control unit). Here, since the brake fluid pressure Pw is regulated by the pressure regulating valve UA in the automatic braking control, neither the inlet valve VI nor the outlet valve VO is energized. Accordingly, during the execution of the automatic braking control, the inlet valve VI is opened, and the outlet valve VO is closed.

In step S110, signals of the braking operation amount Ba, the regulated hydraulic pressure Pp, the wheel speed Vw, the deceleration Gx, the required deceleration corresponding value Fs (Gs, Ps, and the like), an actual energization amount Ia, and a motor rotational frequency Na are read. The braking operation amount Ba (Pm and the like), the regulated hydraulic pressure Pp, the wheel speed Vw, and the deceleration Gx are signals that are respectively detected by the braking operation amount sensor BA (PM and the like), the regulated hydraulic pressure sensor PP, the wheel speed sensor VW, and the deceleration sensor GX. The signal of the corresponding value Fs is acquired from the driver-assistance controller ECJ via the communication bus BS. The actual energization amount Ia is the actual energization amount (for example, the current value) of the pressure regulating valve UA, and is detected by an energization amount sensor (for example, a current sensor) provided to the drive circuit of the controller ECU. The motor rotational frequency Na is an actual rotational frequency of the electric motor MT, and is detected by a rotational frequency sensor provided to the electric motor MT.

In step S120, the various state amounts (state variables) related to vehicle motion are calculated. More specifically, the body speed Vx is calculated on the basis of the wheel speed Vw and a known calculation method. An actually generated vehicle deceleration (actual deceleration) Ga is calculated on the basis of the body speed Vx. More specifically, in regard to the actual deceleration Ga, the body speed Vx is differentiated with time, and this time differential value (referred to as “calculated deceleration”) Ge is used as the actual deceleration Ga. Alternatively, the deceleration Gx (a detection value by the deceleration sensor GX and referred to as “detected deceleration”) can be adopted as the actual deceleration Ga. Furthermore, the actual deceleration Ga may be calculated on the basis of the detected deceleration Gx and the calculated deceleration Ge. In other words, the actual deceleration Ga is calculated on the basis of at least one of the detected deceleration Gx and the calculated deceleration Ge.

In step S130, based on the corresponding value Fs, a required differential pressure Ss as a target value of the differential pressure Sa between the master cylinder hydraulic pressure Pm and the brake fluid pressure Pw is calculated. More specifically, the required differential pressure Ss is calculated in a manner to be increased with an increase in the corresponding value Fs on the basis of a calculation map, which is set in advance. For example, when the braking operation member BP is not operated, “Pm=0”. Thus, the required differential pressure Ss matches the required hydraulic pressure Ps (a value acquired by converting the required deceleration Gs into the hydraulic pressure).

In step S140, it is determined “whether it is necessary to execute the motor stop control”. The “motor stop control” stops the energization of the electric motor MT to bring the rotational frequency thereof to “0” in order to reduce the power consumed by the braking control device SC during the execution of the automatic braking control. More specifically, in step S140, it is determined whether the motor stop control is necessary on the basis of “whether it is necessary to increase the brake fluid pressure Pw”. In other words, “that execution of the motor stop control is necessary” corresponds to “that the brake fluid pressure Pw does not have to be increased”, and “that the execution of the motor stop control is unnecessary” corresponds to “that the brake fluid pressure Pw has to be increased”.

For example, a “case where the brake fluid pressure Pw does not have to be increased” corresponds to a case where the state amount (state variable) related to the required deceleration corresponding value Fs becomes constant or a case where the state amount related to the required deceleration corresponding value Fs is reduced. On the other hand, a “case where the brake fluid pressure Pw has to be increased” corresponds to a case where the state amount related to the required deceleration corresponding value Fs is increased. Accordingly, it is determined that the motor stop control is necessary in “the case where the state amount related to the corresponding value Fs is constant or the case where the state amount related to the corresponding value Fs is reduced”.

The “state amount related to the required deceleration corresponding value Fs” is at least one of the corresponding value Fs itself, the target value calculated according to the corresponding value Fs (that is, the required differential pressure Ss, a required energization amount Is, or the like), the actual value corresponding to the target value (that is, the actual differential pressure Sa or the actual energization amount Ia), and the regulated hydraulic pressure Pp or the brake fluid pressure Pw corresponding to the actual differential pressure Sa. For example, in step S140, at least one of the corresponding value Fs and the actual differential pressure Sa is adopted as the state amount. Then, in the case where a state where the corresponding value Fs becomes constant and the actual differential pressure Sa (consequently, the brake fluid pressure Pw) becomes constant continues for a predetermined time tx (that is, a time point at which duration Tx of such a state reaches the predetermined time tx), the execution of the motor stop control is initiated. The above “constant” means that a state where the corresponding value Fs (that is, the actual differential pressure Sa and the brake fluid pressure Pw) falls within a predetermined range, which is set in advance, continues for the predetermined time tx.

In “the case where the brake fluid pressure Pw has to be increased (for example, the case where the corresponding value Fs is being increased or the case where the duration Tx is shorter than the predetermined time tx)”, it is determined NO in step S140, and the processing proceeds to step S160. If it is determined that “the brake fluid pressure Pw does not have to be increased”, it is determined YES in step S140, and the processing proceeds to step S150. For example, the determination in step S140 (the determination that the brake fluid pressure Pw does not have to be increased) is made YES in a calculation cycle in which the corresponding value Fs becomes constant and the duration Tx of such a state matches the predetermined time tx.

In step S150, it is determined “whether an override operation of the braking operation member BP by the driver has been performed” on the basis of the braking operation amount Ba (for example, the master cylinder hydraulic pressure Pm). The “override operation” means that, when the braking operation member BP is not operated, the vehicle is automatically decelerated on the basis of the corresponding value Fs, but the driver operates the braking operation member BP during the automatic deceleration to request the increase in the vehicle deceleration. For example, the determination on the override operation is made by “whether the braking operation amount Ba is equal to or larger than a predetermined amount ba”. Here, the predetermined amount ba is a predetermined value (constant), which is set in advance.

If the override operation by the driver is not performed (that is, if “Ba<ba”), it is determined NO in step S150, and the processing proceeds to step S170. If the override operation by the driver has been performed (that is, if “Ba≥ba” and the corresponding calculation cycle), it is determined YES in step S150, and the processing proceeds to step S180.

In step S160, normal automatic braking control (also simply referred to as “normal control”) is executed. Here, the “normal control” is the automatic braking control in the case where the motor stop control is not executed. In step S160, the electric motor MT is driven. In drive control for the electric motor MT, servo control is executed such that the motor rotational frequency Na matches a target rotational frequency Nt calculated according to the corresponding value Fs. Alternatively, the rotational frequency Na of the electric motor MT is correlated with the energization amount (the supplied power, and the current value, for example) of the electric motor MT. Accordingly, in the case where the automatic braking control is initiated, a predetermined energization amount may be supplied to the electric motor MT such that the rotational frequency Na becomes a predetermined rotational frequency na, which is set in advance. In such a configuration, for example, as the drive signal Mt of the electric motor MT, an “on signal (on) for rotationally driving the electric motor MT” or an “off signal (off) for stopping the electric motor MT” is instructed to the drive circuit of the controller ECU.

In step S160, in addition to the drive control for the electric motor MT, the energization amount Ia of the pressure regulating valve UA is controlled such that the actual differential pressure Sa matches the required differential pressure Ss. For example, in the case where the braking operation member BP is not operated, “Pm=0”. Thus, the energization amount Ia is regulated such that the regulated hydraulic pressure Pp approaches and matches the required differential pressure Ss (=Ps). More specifically, there is the correlation between “the valve opening amount of the pressure regulating valve UA (consequently, the differential pressure Sa)” and “the energization amount Ia of the pressure regulating valve UA” (a so-called “current-hydraulic pressure characteristic”). Accordingly, as illustrated in a calculation map Z is of a block X160, the required energization amount Is is determined to be increased (rapidly increased) stepwise to a predetermined energization amount io (a predetermined constant, which is set in advance) when the required differential pressure Ss becomes a predetermined value so (a minute constant, which is set in advance). Then, when “Ss>so”, the required energization amount Is is calculated to be increased with the increase in the required differential pressure Ss.

Energization amount feedback control is executed such that the actual energization amount Ia (actual value) approaches and matches the required energization amount Is (target value). In the configuration that the regulated hydraulic pressure sensor PP is provided, the actual differential pressure Sa can be detected. Thus, hydraulic pressure feedback control may be executed on the basis of the required differential pressure Ss (target value) and the actual differential pressure Sa (detection value). Furthermore, deceleration feedback control may be executed such that the actual deceleration Ga approaches and matches the required deceleration Gs.

In step S170, the motor stop control is executed for power saving of the braking control device SC. In step S170, the pressure regulating valve UA is closed, and driving of the electric motor MT is stopped. By closing the pressure regulating valve UA, the brake fluid pressure Pw is held, and driving of the electric motor MT can be stopped. More specifically, in step S170, a predetermined energization amount (referred to as a “holding energization amount”) ip is added to an energization amount ia (for example, a current value and referred to as a “reference energization amount”) in a state where the corresponding value Fs (=Sa) is constant. A sum of the reference energization amount ia and the holding energization amount ip (that is, “ia+ip”) is supplied to the pressure regulating valve UA. In other words, the energization amount Ia, which is supplied to the pressure regulating valve UA, is increased from the reference energization amount ia by the holding energization amount ip. For example, the energization amount Ia is increased stepwise (that is, rapidly increased).

The rotary member (brake disc) KT possibly experience runout (displacement in a direction orthogonal to a rotation axis) when rotating. Due to the runout, a brake piston is possibly pushed, which slightly increases the brake fluid pressure Pw. Accordingly, in the case where the slightly larger energization amount Ia than the reference energization amount ia is supplied to the pressure regulating valve UA and the pressure regulating valve UA is then closed, the pressure regulating valve UA is possibly and unintentionally opened due to the runout of the rotary member KT. For this reason, the holding energization amount ip is applied to the pressure regulating valve UA, so as to reliably close the pressure regulating valve UA. In other words, the holding energization amount ip is a predetermined energization amount, which is set in advance to prevent opening of the pressure regulating valve UA even with the increase in the brake fluid pressure Pw caused by the runout of the rotary member KT.

The reference energization amount ia is a value that corresponds to the corresponding value Fs and is, for example, the energization amounts Is, Ia immediately before driving of the electric motor MT is stopped. Meanwhile, the holding energization amount ip is a predetermined amount (constant), which is set in advance and is an energization amount for completely closing the pressure regulating valve UA. Thus, the reference energization amount is is the energization amount before being increased by the holding energization amount ip. At the same time as or immediately after increasing the required energization amount Is (consequently, the actual energization amount Ia) by the holding energization amount ip, the power supply to the electric motor MT is stopped, and the rotation of the electric motor MT is stopped (that is, “Na=0”).

In step S180, motor re-drive control is executed in the case where the override operation of the braking operation member BP is performed during the execution of the motor stop control. In the motor stop control, the differential pressure Sa (=Pw) is maintained at the constant hydraulic pressure due to the closed position of the pressure regulating valve UA. However, in step S180, the electric motor MT is driven again to reflect the braking operation amount Ba of the braking operation member BP to the brake fluid pressure Pw, and the differential pressure Sa is regulated by the pressure regulating valve UA. More specifically, the electric motor MT is rotationally driven, the reference energization amount is is supplied to the pressure regulating valve UA, and the differential pressure Sa is maintained to bring back the state before the execution of the motor stop control. At this time, the master cylinder hydraulic pressure Pm is increased from “0” by the override operation. Thus, in the case where the corresponding value Fs is constant, the brake fluid pressure Pw becomes a hydraulic pressure that is acquired by adding the differential pressure Sa to the master cylinder hydraulic pressure Pm (that is, “Pw=Pm+Sa”).

### Actuation of Motor Stop Control

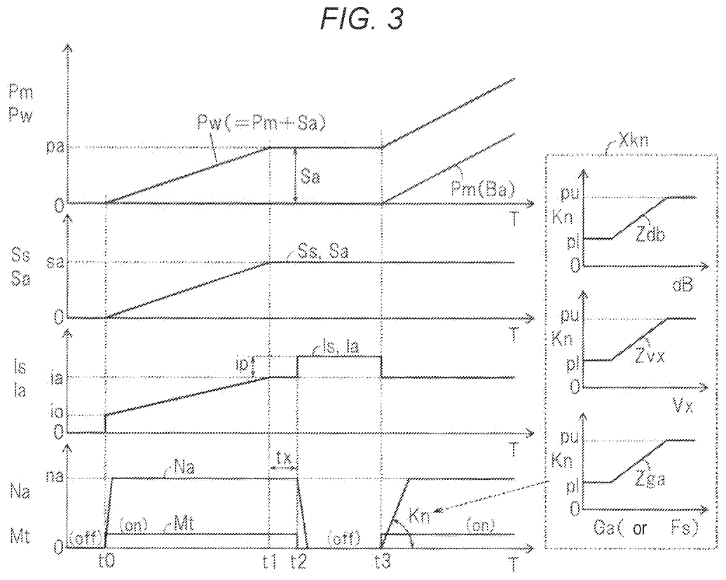

A description will be made on actuation of the automatic braking control including the motor stop control with reference to time charts (changes in the various state amounts Pw, Sa, Na, and the like with respect to time T) in FIG. 3. In regard to the actuation, the configuration of the braking control device SC in FIG. 1, from which the regulated hydraulic pressure sensor PP is omitted, is adopted. In addition, the required deceleration corresponding value Fs is adopted as the state amount related to the required deceleration corresponding value Fs. Since driving of the electric motor MT is stopped by the motor stop control during the execution of the automatic braking control, the power saving for the braking control device SC is achieved.

In the charts, the following situation is assumed. The driver does not operate the braking operation member BP, and the automatic braking control is first initiated. Thereafter, the motor stop control is executed, and in the middle of the control, the override operation of the braking operation member BP is performed by the driver. Thus, the stopped electric motor MT is driven again. In the charts, the target values (Ss, Is) and the actual values (Sa, Ia) substantially match and overlap each other.

In the case where the driver does not operate the braking operation member BP (that is, Pm=0), at a time point to, the required deceleration corresponding value Fs (for example, the required deceleration Gs itself) is increased from “0”, and the automatic braking control (the processing in step S160) is initiated. At the time point to, the motor drive signal Mt is switched from the “off state” to the “on state”. In this way, the electric motor MT is energized, and the motor rotational frequency Na is increased to the value na (the predetermined rotational frequency, and the constant, which is set in advance) (due to rotor inertia of the electric motor MT or the like, it takes a little time to reach the predetermined rotational frequency na). In addition, with the increase in the corresponding value Fs, the required energization amount Is is rapidly increased from “0” to the value io by following the above correlation between the energization amount and the differential pressure (for example, the current-hydraulic pressure characteristic), and the energization amount Ia starts being supplied to the pressure regulating valve UA. At the time point t0 onward, the energization amounts Is, Ia are gradually increased, and the valve opening amount of the pressure regulating valve UA is reduced, so as to gradually increase the differential pressure Sa. As a result, the regulated hydraulic pressure Pp is increased, the brake fluid pressure Pw (=Sa) of each of the four wheel cylinders CW is gradually increased, and the vehicle is smoothly decelerated according to the required deceleration corresponding value Fs.

At a time point t1, the corresponding value Fs is made to be constant. Although driving of the electric motor MT continues, the power supply amounts Is (the target value), Ia (the actual value) to the pressure regulating valve UA are made to be constant at the value ia. Accordingly, the pressure regulating valve UA is opened according to the energization amount ia, the differential pressure Sa is maintained to be constant, and the brake fluid pressure Pw is held at a value pa. At this time, the calculation (integration) of the duration Tx is initiated. It is determined until a time point t2 that “the brake fluid pressure Pw has to be increased”. Thus, the motor stop control is not executed.

At the time point t2, it is determined that “the brake fluid pressure Pw does not have to be increased”. For example, the determination is made Yes at a time point (the corresponding calculation cycle) when the duration Tx, in which the corresponding value Fs (consequently, the differential pressure Sa) falls within the predetermined range, reaches the predetermined time tx. At the time point t2, the motor stop control (the processing in step S170) is initiated. The supplied energization amount Is to the pressure regulating valve UA is increased (rapidly increased) from the reference energization amount ia by the holding energization amount ip (the constant, which is set in advance). As a result, the actual energization amount Ia is increased (rapidly increased stepwise) from the reference energization amount ia by the holding energization amount ip. For example, at the time point t2, the reference energization amount ia is stored. Until the time point t2, the normally-open pressure regulating valve UA is opened in the manner to throttle the recirculation flow KN. However, after the time point t2, the pressure regulating valve UA is reliably brought to the closed position by the increase corresponding to the holding energization amount ip. As a result, even in the case where the brake fluid pressure Pw fluctuates due to the runout of the rotary member (brake disc) KT, or the like, the pressure regulating valve UA is not opened and is reliably maintained in the closed state.

Then, the motor drive signal Mt is switched from “on” to “off”, and the rotational frequency Na of the electric motor MT is reduced from the predetermined rotational frequency na toward “0”. With closing of the pressure regulating valve UA, the brake fluid BF in the downstream portion of the pressure regulating valve UA (that is, the brake fluid BF in the wheel cylinder CW) is sealed. Accordingly, even in the case where rotational driving of the electric motor MT is stopped, the brake fluid pressure Pw is held at the value pa. Thus, energy that corresponds to the power supply amount to the electric motor MT is reduced, and the power saving for the braking control device SC is thereby achieved. In the charts, the stop of the electric motor MT and the closing of the pressure regulating valve UA are performed simultaneously. However, the electric motor MT may be stopped after a lapse of a predetermined time (an extremely short time, and referred to as “valve closing duration”) from closing of the pressure regulating valve UA. In other words, the electric motor MT is stopped at the same time as or immediately after the pressure regulating valve UA is closed. After the time point t2 onward, the execution of the motor stop control continues unless the driver operates the braking operation member BP.

At a time point t3, the driver operates the braking operation member BP, and the master cylinder hydraulic pressure Pm is increased. At the time point t3, it is determined that the braking operation member BP is operated (that is, the override operation is performed). In the braking control device SC, the stopped electric motor MT is driven again to maintain the differential pressure Sa (the hydraulic pressure difference between the master cylinder hydraulic pressure Pm and the brake fluid pressure Pw). At this time, the energization amount of the pressure regulating valve UA is regulated, and the pressure regulating valve UA is opened. In detail, the energization amount Ia supplied to the pressure regulating valve UA is reduced (for example, rapidly reduced stepwise) by the holding energization amount ip. As a result, the recirculation flow KN of the brake fluid BF, which is discharged by the fluid pump HP, is throttled again by the pressure regulating valve UA, and the differential pressure Sa is thereby maintained.

By the fluid pump HP, the brake fluid BF is suctioned from the connection path HS between the master cylinder CM and the pressure regulating valve UA, and is discharged to the connection path HS between the pressure regulating valve UA and the wheel cylinder CW. When the electric motor MT is driven again, the brake fluid BF is suctioned from the master cylinder CM (that is, the hydraulic chamber Rm). However, when the motor rotational frequency Na is rapidly increased, the master cylinder hydraulic pressure Pm is changed (slightly reduced) due to the state where the pressure regulating valve UA is not fully opened. As a result, the operation force Fp fluctuates. In order to solve such a circumstance, when the motor stop control is terminated and the execution of the motor re-drive control is initiated, a temporal change amount dN (a positive slope, and a change amount of the motor rotational frequency Na with respect to the time T) of the rotational frequency Na of the electric motor MT is limited by a limit value Kn. For example, the limit value Kn is set as a predetermined slope (constant), which is set in advance. In addition, as illustrated in a block Xkn, the limit value Kn may be calculated on the basis of at least one of a braking operation speed dB, the body speed Vx, and the actual deceleration Ga (or the corresponding value Fs). In regard to limiting the positive slope dN of the rotational frequency Na, the target rotational frequency Nt of the electric motor MT is limited by the limit value Kn, and the actual rotational frequency Na is controlled to match this target rotational frequency Nt. In addition, the energization amount (the power supply amount) of the electric motor MT may be limited according to the limit value Kn. A description will hereinafter be made on variable setting of the limit value Kn.

For example, in the motor re-drive control, the operation speed dB of the braking operation member BP is calculated on the basis of the braking operation amount Ba. Then, the limit value Kn is calculated on the basis of the operation speed dB (a time differential value of the braking operation amount Ba) at the time point t3, at which the override operation of the braking operation member BP is performed (the calculation cycle when the determination of YES in step S150 is switched to NO). At this time, as the braking operation amount Ba, the operation displacement Sp (the detection value by the operation displacement sensor SP) is desirably adopted. This is because the master cylinder hydraulic pressure Pm is affected by the fluctuation caused by the rapid increase in the motor rotational frequency Na, but the operation displacement Sp is the state amount that is acquired by directly detecting the operation amount of the braking operation member BP and thus is less affected by the fluctuation. The limit value Kn is set according to the braking operation speed dB and a calculation map Zdb such that the limit value Kn is increased with an increase in the operation speed dB. That is, in the case where the braking operation member BP is rapidly operated, it is difficult to limit the temporal change amount dN of the motor rotational frequency Na. This is because, at the time of the rapid operation of the braking operation member BP, the increase of the brake fluid pressure Pw is prioritized over improvement in operation feeling of the braking operation member BP (that is, suppression of the fluctuation in the operation force Fp).

In the motor re-drive control, the limit value Kn is determined on the basis of the body speed Vx. More specifically, the limit value Kn is set according to the body speed Vx at the time point t3, at which the override operation of the braking operation member BP is performed, and a calculation map Zvx such that the limit value Kn is increased with the increase in the body speed Vx. That is, in the case where the body speed Vx is high, it is difficult to limit the temporal change amount dN of the motor rotational frequency Na. This is because, during high-speed travel, the increase of the brake fluid pressure Pw (that is, the increase of the deceleration of the vehicle) is prioritized over the suppression of the fluctuation in the operation force Fp.

In the motor re-drive control, the limit value Kn is determined on the basis of the actual deceleration Ga. More specifically, the limit value Kn is set according to the actual deceleration Ga at the time point t3, at which the override operation of the braking operation member BP is performed, and a calculation map Zga such that the limit value Kn is increased with the increase in the actual deceleration Ga. That is, in the case where the actual deceleration Ga is high, it is difficult to limit the temporal change amount dN of the motor rotational frequency Na. This is because, when the deceleration of the vehicle is high, the increase of the brake fluid pressure Pw (that is, the increase of the deceleration of the vehicle) is prioritized over the suppression of the fluctuation in the operation force Fp. Due to the above-described reasons, instead of the actual deceleration Ga, at least one of the detected deceleration Gx, the calculated deceleration (the time differential value of the body speed Vx) Ge, and the corresponding value Fs may be adopted. In addition, an upper limit value ku and a lower limit value kl may be provided for the calculation of the limit value Kn according to the various calculation maps Zdb, Zvx, Zga.

### Summary of Embodiment and Operational Effects

Hereinafter, the configuration and operational effects of the braking control device SC according to the present disclosure will be summarized.

In the braking control device SC, when the braking operation member BP is not operated, the automatic braking control is executed to decelerate the vehicle by automatically increasing the brake fluid pressure Pw, which is the hydraulic pressure in the wheel cylinder CW. The braking control device SC is provided with: the “pressure regulating valve UA that is provided to the connection path HS for connecting the master cylinder CM and the wheel cylinder CW and regulates the differential pressure Sa between the master cylinder hydraulic pressure Pm as the hydraulic pressure in the master cylinder CM and the brake fluid pressure Pw as the hydraulic pressure in the wheel cylinder CW”; the “fluid pump HP that is driven by the electric motor MT, suctions the brake fluid BF from the connection path HS between the master cylinder CM and the pressure regulating valve UA, and discharges the brake fluid BF into the connection path HS between the pressure regulating valve UA and the wheel cylinder CW”; and the “controller ECU that controls the pressure regulating valve UA and the electric motor MT”.

In the braking control device SC, in the case where the brake fluid pressure Pw no longer has to be increased after the increase in the brake fluid pressure Pw, the controller ECU closes the pressure regulating valve UA and stops driving the electric motor MT. More specifically, the pressure regulating valve UA is of the normally-open type. At the time point, at which it is determined that the brake fluid pressure Pw does not have to be increased (for example, at the time point at which the required deceleration corresponding value Fs becomes constant), the controller ECU increases the energization amount Ia to be supplied to the pressure regulating valve UA by the holding energization amount ip as the predetermined value. Here, the “state amount related to the required deceleration corresponding value Fs” is at least one of: the corresponding value Fs itself; the actual differential pressure Sa as the result corresponding to the required differential pressure Ss, which is calculated on the basis of the required deceleration corresponding value Fs, the required energization amount Is, and the required deceleration corresponding value Fs; the regulated hydraulic pressure Pp; the brake fluid pressure Pw; and the actual energization amount Ia. In addition, “constant” means that the state where the state variable falls within the predetermined range (constant) continues for the predetermined time tx.

In the case where the state amount (Fs, Ss, and the like) related to the required deceleration corresponding value Fs becomes constant, and the brake fluid pressure Pw no longer has to be increased, the differential pressure Sa (=Pw), which is controlled according to the corresponding value Fs, remains constant, and such a state can be maintained (ultimately, the braking force can be maintained) by closing the pressure regulating valve UA. Thus, the power supply to the electric motor MT is stopped, and the power saving for the braking control device SC is achieved. In order to further reliably hold the brake fluid pressure Pw by the closed state of the pressure regulating valve UA, the electric motor MT is preferably stopped immediately after a closing instruction to the pressure regulating valve UA (that is, the increase of the predetermined holding energization amount ip) is made.

In the braking control device SC, in the case where the braking operation member BP is operated (that is, during the override operation) in the state where the automatic braking control is executed and driving of the electric motor MT is stopped (that is, during the motor stop control), the controller ECU provides the limit value Kn to the temporal change amount dN of the rotational frequency Na of the electric motor MT and drives the electric motor MT again.

In the case where the override operation is performed, the pressure regulating valve UA, which has been closed, is opened to reflect the operation of the braking operation member BP by the driver to the brake fluid pressure Pw. At this time, in the case where the rotational frequency Na of the electric motor MT is rapidly increased, the master cylinder hydraulic pressure Pm fluctuates, which possibly degrades the operation feeling of the braking operation member BP. In order to avoid such a circumstance, the temporal change amount dN of the motor rotational frequency Na is limited when the electric motor MT is driven again. In this way, the fluctuation in the master cylinder hydraulic pressure Pm is suppressed, and the operation feeling of the braking operation member BP can be improved.

### Another Embodiment

In the above embodiment, the diagonal fluid path is adopted as the fluid path of the two systems. Instead of this, a front-rear (also referred to as a “II-type”) fluid path may be adopted as the fluid path of the two systems. In this case, the first hydraulic chamber Rm1 of the master cylinder CM is connected to the wheel cylinders CW of the right and left front wheels, and the second hydraulic chamber Rm2 is connected to the wheel cylinders CW of the right and left rear wheels. Similar effects as those described above are exerted with such a configuration.

1. A braking control device for a vehicle that decelerates a vehicle by automatically increasing a brake fluid pressure as a hydraulic pressure in a wheel cylinder at the time when a braking operation member is not operated, the braking control device for a vehicle comprising:
a pressure regulating valve that is provided to a connection path for connecting a master cylinder and the wheel cylinder and regulates a differential pressure between a master cylinder hydraulic pressure as a hydraulic pressure in the master cylinder and the brake fluid pressure;
a fluid pump that is driven by an electric motor and discharges a brake fluid into the connection path between the pressure regulating valve and the wheel cylinder; and
a controller that controls the pressure regulating valve and the electric motor, wherein
in the case where the brake fluid pressure no longer has to be increased, the controller closes the pressure regulating valve and stops driving the electric motor.

2. The braking control device for a vehicle according to claim 1, wherein
the pressure regulating valve is of a normally-open type, and
the controller increases an energization amount to be supplied to the pressure regulating valve by a predetermined energization amount at a time point at which the brake fluid pressure no longer has to be increased.
